(19) United States
(12) Patent Application Publication
(10) Pub. No.: US 2016/0374278 A1
(43) Pub. Date: Dec. 29, 2016

(54) ANTIMICROBIAL COMPOSITE MAT FOR WATER DISTRIBUTION AND SELF-WATERING OF POTTED PLANTS

(71) Applicant: WATERPULSE, INC., Longmont, CO (US)

(72) Inventors: Yugen Patrick Lockhart, Palo Alto, CA (US); Ronald L. Johnson, San Jose, CA (US)

(21) Appl. No.: 15/260,556

(22) Filed: Sep. 9, 2016

Related U.S. Application Data
(63) Continuation-in-part of application No. 13/914,454, filed on Jun. 10, 2013.

(51) Int. Cl. A01G 27/04

(52) U.S. Cl. CPC A01G 27/04

(57) ABSTRACT

A composite mat for water distribution to one or more potted plants comprises a bottom layer, a top layer and a core layer positioned between the bottom layer and the top layer. After water is distributed to the mat, the water is distributed evenly across the entirety of the core layer. When one or more potted plants are placed on the mat, water is passed from the core layer to the one or more potted plants and the plants are watered. The core layer is able to contain a antimicrobial substance, including silver sodium hydrogen zirconium phosphate. The antimicrobial substance is able to be less than 1% of a weight of the core layer.

### RELATED APPLICATIONS

This application is a continuation-in-part of the co-pending nonprovisional U.S. patent application Ser. No. 13/914,454, filed Jun. 10, 2013, published as United States Patent Application Publication No. 2016/0128287, and entitled “COMPOSITE MAT FOR WATER DISTRIBUTION AND SELF-WATERING OF POTTED PLANTS”, which is hereby incorporated by reference in its entirety.

### FIELD OF THE INVENTION

This invention relates to devices and methods for watering plants. More particularly, the invention relates to devices and methods for watering potted plants individually and in large quantities.

### BACKGROUND OF THE INVENTION

Typically a potted plant or a group of potted plants is watered by spraying or pouring water over the leaves and soil of the potted plants. In some instances the water is distributed manually by a garden hose with a pressure nozzle or the water is automatically provided by a timed sprinkler or watering system. In either case, the water is provided in a top-down manner to the potted plants with the water first contacting the leaves and then the soil of the potted plants. With such a system, it is difficult to determine how much water is actually received by the plants and the potted plants may be over or under watered. Additionally, if the potted plants are spaced over a large area the plants close to the watering source may receive a strong burst of water causing soil and desired nutrients to be flushed from the pots, while the further spaced plants may not receive any water at all. In order to provide a uniform distribution of water to the group of plants much care and attention must be given to the precise amount of water each plant receives. However, such a system may be time consuming and costly as the plants are continuously monitored and thus eliminating the desirability of keeping the potted plants.

### SUMMARY OF THE INVENTION

A composite mat for water distribution to one or more potted plants comprises a bottom layer, a top layer and a core layer positioned between the bottom layer and the top layer. After water is distributed to the mat, the water is distributed evenly across the entirety of the core layer. When one or more potted plants are placed on the mat, water is passed from the core layer to the one or more potted plants and the plants are watered.

In one aspect, a water distribution mat for one or more potted plants comprises a base layer, a top layer, and a core layer for retaining water and distributing the water through the top layer and to the one or more potted plants located on the mat. In some embodiments, the top layer is perforated. In some embodiments, the core layer is configured to uniformly distribute water across its volumetric area. In further embodiments, the base layer holds excess stored water not contained within the core layer. In still further embodiments, excess water located on the top layer drains back into the core layer for later use. In some embodiments, the mat comprises an edge coupled to the base layer, the top layer, and the core layer, wherein the edge seals the contained water in within the core layer and contains the excess water on the top layer before it is drained into the core layer. In further embodiments, the mat comprises a wicking tab for wicking excess water from the mat. In some embodiments, the top layer is flexible and the one or more potted plants depress into the core layer when the one or more potted plants are placed on the mat. In some embodiments, the top layer comprises a woven slit-film propylene material with a warp and weft between 95 lbs and 195 lbs and a water permeability of 12 to 20 GPM/SqFt. In some embodiments, the core layer comprises a needled polyester viscose or lyocel non-woven felt substrate. In some embodiments, the base layer comprises a polyethylene film material.

In another aspect, a bottom-up water distribution system for one or more potted plants comprises a perforated top layer comprising a slit-film propylene material, a core layer comprising a needled polyester viscose or lyocel non-woven felt substrate and for holding a quantity of water; and a base layer comprising a polyethylene film material. In some embodiments, excess water located on the top layer drains back into the core layer for later use. In some embodiments, the system comprises an edge coupled to the base layer, the top layer, and the core layer, wherein the edge seals the contained water within in the core layer and contains the excess water on the top layer before it is drained into the core layer. In some embodiments, the core layer is configured to uniformly distribute water across its volumetric area. In further embodiments, the base layer holds excess stored water not contained within the core layer. In some embodiments, the system comprises a wicking tab for wicking excess water from the mat. In some embodiments, the top layer is flexible and the one or more potted plants depress into the core layer when the one or more potted plants are placed on the mat.

In a further aspect, a method of watering one or more potted plants comprises supplying water to a composite mat comprising a base layer, a top layer and a core layer, and placing the one or more potted plants on the composite mat, wherein water is retained within the core layer and distributed through the top layer and to the one or more potted plants. In some embodiments, excess water not currently needed by the one or more potted plants is stored within the composite mat for later use. In some embodiments, water is distributed to the plant in a consistent manor and as needed by the one or more potted plants over a plurality of watering cycles.

In a further aspect, a water distribution mat for one or more potted plants comprises a base layer, a top layer, and a core layer for retaining water and distributing the water through the top layer and to the one or more potted plants located on the mat, wherein the core layer comprises an antimicrobial substance. In some embodiments, the antimicrobial substance comprises silver sodium hydrogen zirconium phosphate. In other embodiments, the antimicrobial substance comprises a silver compound. In some other embodiments, the antimicrobial substance comprises zirconium. In some embodiments, the zirconium comprises a zirconium phosphate compound. In other embodiments, the core layer comprises a fabric based material containing the antimicrobial substance.

In another aspect, a bottom-up water distribution system for one or more potted plants comprises a perforated top layer comprising a slit-film propylene material, a core layer comprising a needled polyester viscose or lyocel non-woven felt substrate and for holding a quantity of water, wherein the core layer comprises an antimicrobial substance, and a base layer comprising a polyethylene film material. In some embodiments, the antimicrobial substance comprises silver sodium hydrogen zirconium phosphate. In other embodiments, the antimicrobial substance comprises a silver compound. In some other embodiments, the antimicrobial substance comprises a zirconium phosphate compound.

In a further aspect, a method of watering one or more potted plants comprising supplying water to a composite mat comprising a base layer, a top layer, and a core layer, wherein the core layer comprises an antimicrobial substance and placing the one or more potted plants on the composite mat, wherein water is retained within the core layer and distributed through the top layer and to the one or more potted plants. In some embodiments, the antimicrobial substance comprises silver sodium hydrogen zirconium phosphate. In other embodiments, the antimicrobial substance comprises a silver compound. In some other embodiments, the antimicrobial substance comprises a zirconium compound.

In another aspect, a method of watering one or more potted plants comprises supplying water to a water distributing layer of a composite mat, wherein the water distributing layer comprises an antimicrobial substance, and placing the one or more potted plants on the composite mat, wherein water is retained within the water distributing layer and distributed through a top layer and to the one or more potted plants. In some embodiments, the antimicrobial substance comprises silver sodium hydrogen zirconium phosphate. In other embodiments, the water distributing layer comprises polyester viscose. In some other embodiments, the water distributing layer comprises a non-woven felt substrate. In some embodiments, the top layer comprises a slit-film material. In other embodiments, the top layer comprises a porous film material.

### BRIEF DESCRIPTION OF THE DRAWINGS

FIG. 1 illustrates a partially exploded view of a water distribution mat for one or more potted plants in accordance with some embodiments.

FIG. 2 illustrates a water distribution mat for one or more potted plants in accordance with some embodiments.

FIG. 3 illustrates a water distribution mat holding one or more potted plants in accordance with some embodiments.

FIG. 4 illustrates a method of watering one or more potted plants in accordance with some embodiments.

FIG. 5 illustrates an antimicrobial core layer in accordance with some embodiments.

FIG. 6 illustrates a method of making the antimicrobial core layer in accordance with some embodiments.

### DETAILED DESCRIPTION OF THE INVENTION

In the following description, numerous details are set forth for purpose of explanation. However, one of ordinary skill in the art will realize that the invention may be practiced without the use of these specific details or with equivalent alternatives. Thus, the presently claimed invention is not intended to be limited to the embodiments shown but is to be accorded the widest scope consistent with the principles and features described herein. Throughout the description similar components are similarly marked in order to aid comprehension.

Embodiments of the invention are directed to a composite mat for watering potted plants individually or in large quantities. The watering mat comprises a base layer, a top layer and a core layer positioned between the base layer and the top layer. When water is distributed to the mat, the water is uniformly distributed throughout the core layer. When one or more potted plants are place on the watering mat, the water is distributed in an upward direction from the core and through the top layer to the one or more plants.

Referring now to FIG. 1, a partially exploded view of a water distribution mat for one or more potted plants is depicted therein. The water distribution mat 100 comprises a base layer 101, a top layer 105 and a core layer 103 positioned between the base layer 101 and the top layer 105. In some embodiments, the water distribution mat 100 further comprises an edge 107 coupled to the base layer 101, the top layer 105 and the core layer 103 and surrounding an outer perimeter of the water distribution mat 100. In some embodiments, the mat 100 comprises one or more wicking tabs 109 for wicking excess moisture from the water distribution mat 100.

The mat 100 is configured to receive water from an external source and distribute and uniformly retain the water across the interior core layer 103. In some embodiments, the mat 100 is configured to distribute and uniformly retain the water across the interior core layer 103 over a mild incline such as a standard flat surface drainage slope. When a potted plant is placed on the water distribution mat 100, water is passed up through the mat 100 to the potted plant. In some embodiments, the water is passed up to the potted plant by capillary action. Any appropriate style of pot is able to be used so long as it is able to receive water in a bottom-up fashion. For example, in some embodiments, the pot comprises one or more holes, slots, or channels that enable water to be passed up to the potted plant.

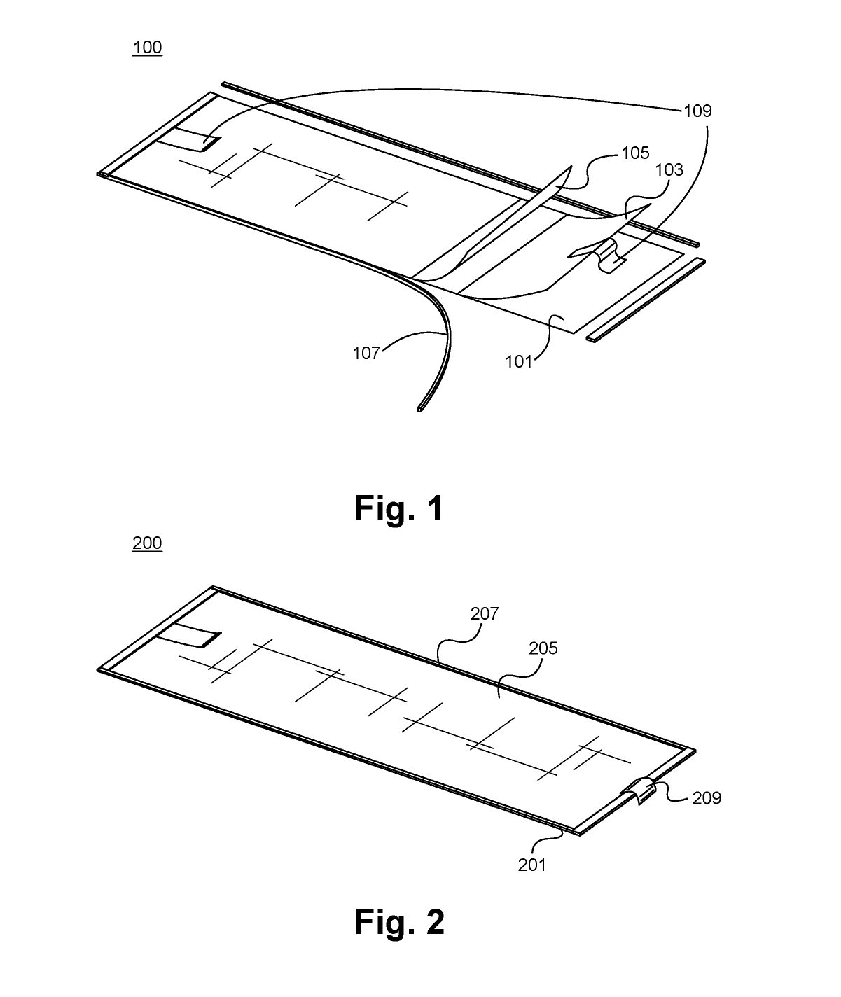

FIG. 2 illustrates a water distribution mat in an assembled configuration. The water distribution mat 200 is similar to the water distribution mat 100, as described above. The water distribution mat 200 comprises a base layer 201, a top layer 205, an edge 207, and one or more wicking tabs 209. The mat 200 also comprises a core layer between the base layer 201 and the top layer 205, such as described above. As shown in FIG. 2, the edge 207 completely surrounds the perimeter of the water distribution mat 200.

When water and/or fluid such as a nutrient mix is distributed to the mat 200, the water and/or fluid is uniformly distributed throughout the core layer. The core layer is configured to uniformly distribute water and/or fluid across its volumetric area and retain the water and/or fluid so that it is available upon demand by the plant soil and the roots of a potted plant. In some embodiments, the core layer comprises a Geotextile fabric such as a needled Polyester/Vicose or Lyocel non-woven felt type substrate. Particularly, the core layer is designed for an optimal desired level of moisture retention and distribution. Accordingly, the core layer is able to comprise any material which delivers the desired level of moisture retention and distribution. In some embodiments, the fiber content of the core layer comprises approximately 50% (+−5%) Polyester (moisture regain of Polyester [ASTM D 1909-2012] 0.4%) and approximately 50% (+−5%) Viscose (Rayon) (moisture regain of Viscose (Rayon) per [ASTM D 1909-2012] 11.02%) (or Lyocel (Tencel) (moisture regain of Lyocel (Tencel) 5%-8%) and the fiber denier comprises 2.5 (+−0.5). In some embodiments, the weight of the core layer comprises 6.5 oz/SqYd and the thickness 0.105″ (2.7 mm) with a weight to thickness ratio of 2.4 oz/lmm of thickness/SqYd (+−0.2 oz). However, the core layer is able to comprise any appropriate material or total thickness designed to meet the desired application.

In order to distribute water to one or more potted plants, the water within the core layer passes through the core layer and up through the top layer 205 and to the one or more potted plants. In some embodiments, the top layer 205 comprises a mesh or perforated layer. The top layer 205 protects the core layer and minimizes moisture evaporation by shading the water within the core layer and catching and re-condensing moisture vapor from the core layer as it rises and tries to escape. In some embodiments, the top layer 205 comprises a slit style woven Polypropylene material. In some embodiments, the top layer 205 comprises a weight of approximately 3.2 oz/SqYd and a water permeability of 12-20 GPM/SqFt. In some embodiments, the top layer 205 comprises a warp and a weft tensile strength within the range of 95 lbs-195 lbs. In some embodiments the top layer 205 comprises a UV resistance of approximately 70% after 2500 hrs (Xenon Arc or Carbon Arc). The top layer 205 is able to comprise any appropriate material in order to protect the core layer and minimize moisture evaporation from the stored water. For example, in some embodiments, the top layer 205 comprises Monofilament Polypropylene, Polyethylene, Polyamide Vinyl, Thermoplastic Rubber or other porous material which is able to handle abrasion and keep evaporation to a minimum. The top layer 205 is flexible so that it flexes or buckles under the load of a potted plant and allows the potted plant to depress slightly into the soft core layer below the top layer 205.

As stated above, when water is distributed to the mat 200, the water is uniformly distributed throughout the core layer. In some embodiments, extra water which is not contained within the core layer is stored within the base layer 201. The base layer 201 is configured to contain excess stored water and/or fluid and prevent the water and/or fluid from being leaked, absorbed or being drained from the mat (beyond supplying water to the one or more potted plants). In some embodiments, the base layer 201 comprises a Polyethylene blown film or extruded film material. For example, in some embodiments, the base layer 201 comprises a virgin Polyethylene film material which is 200 microns thick (8.0 mill). In some embodiments the base layer 201 comprises a UV resistance of approximately 70% after 2500 hrs (Xenon Arc or Carbon Arc). The base layer 201 is able to comprise any appropriate material configured to contain excess stored water and/or fluid and prevent the water and/or fluid from being leaked, absorbed or being drained from the mat.

As shown in FIG. 2, the edge 207 completely surrounds the water distribution mat 200. In some embodiments, the edge comprises a rolled edge of the base layer 201, which is rolled and bonded to the top layer 205 and the core layer. Alternatively, in some embodiments, the edge 207 is a separate component or material which is bonded with the base layer 201, the top layer 205 and the core layer. The edge 207 is configured to 1) cosmetically finish the mat 200, while bonding to the base layer 201, the top layer 205 and the core layer; 2) contain the edge and seal the water within the core layer; and 3) contain any temporary pooling of excess water residing on the top layer 205 before the water has drained back into the core layer of the mat 200. In some embodiments, the edge 207 comprises a raised berm on an outside perimeter of the edge 207. The berm enables the edge 207 to easily contain the excess water residing on the top layer 205. In some embodiments, the edge 207 comprises an extruded medium-low durometer vinyl material. However, the edge 207 is able to comprise any appropriate flexible rubber-like material which is able to bond with the base layer 201, the top layer 205 and the core layer and contain water within the mat 200. In some embodiments, the edge 207 is joined on, cast in place, or placed on top. However, the edge 207 is able to couple with the water distribution mat 200 by any appropriate manufacturing process.

As further shown within FIG. 2, in some embodiments, the water distribution mat comprises one or more wicking tabs 209. The one or more wicking tabs 209 are configured to wick any excess water from the water distribution mat 200 in the event that the mat 200 is overfilled. In some embodiments, the one or more wicking tabs 209 comprise an excess of the integral fibers of the core layer. Alternatively, in some embodiments, the one or more wicking tabs 209 are seperately added during manufacture of the mat 200. The one or more wicking tabs 209 are able to be more or less effective at transferring liquid depending upon the desired application.

The water distribution mat is able to be manufactured in any appropriate size depending upon the desired use. For example, in some embodiments, the watering mat is 2′×8′ with a width of 24″ (+−0.5″), and a length of 96″ (+0.5″, −1.0″), 17.5″×6′ with a width of 17.5″ (+−0.5″), and a length of 72″ (+0.5″, −1.0″), or 3′×6′ with a width of 34″ (+−0.5″), and a length of 72″ (+0.5″, −1.0″). In some embodiments, the outside edge of the water distribution mat comprises a height of 0.287″ (7.3 mm) However, as will be apparent to someone of ordinary skill in the art, the watering mat is able to be manufactured in any appropriate configuration and size profile. For example, in some embodiments, the water distribution mat is manufactured in the shape of a square, a rectangle, a triangle, a circle, a half or partial circle, or other custom shape and size.

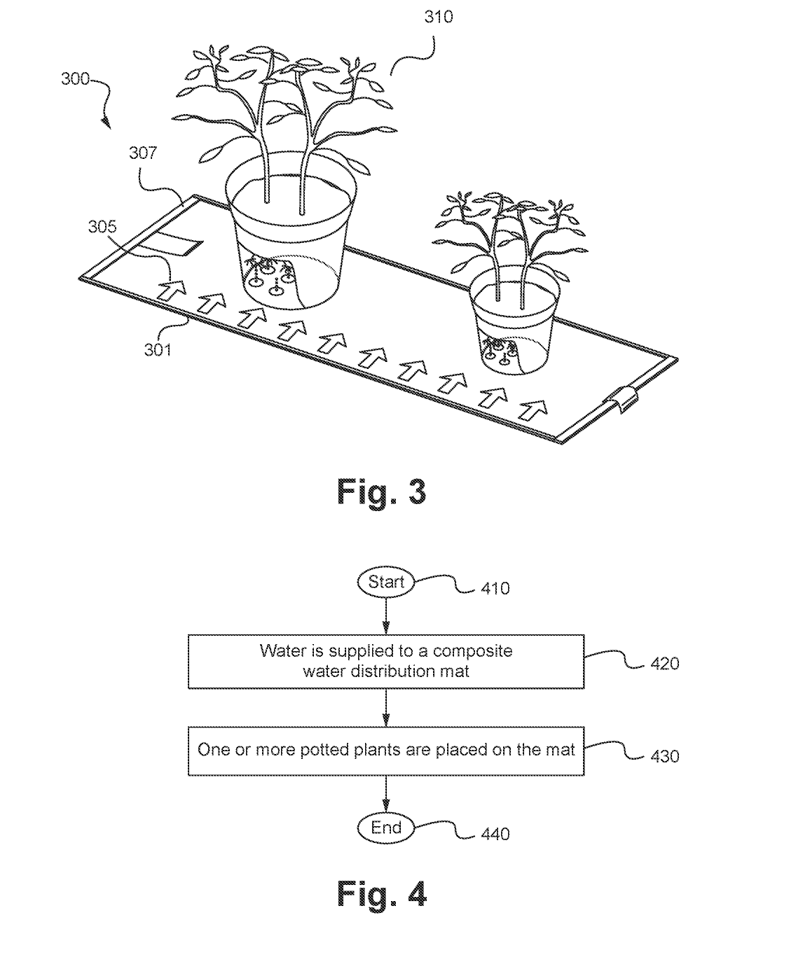

FIG. 3 illustrates a water distribution mat holding one or more potted plants in accordance with some embodiments. The water distribution mat 300 is similar to the water distribution mats 100 and 200, as described above. The water distribution mat 300 comprises a base layer 301, a top layer 305, an edge 307, and one or more wicking tabs (not shown). The mat 300 also comprises a core layer between the base layer 301 and the top layer 305, such as described above. As shown in FIG. 3, the edge 307 completely surrounds the perimeter of the water distribution mat 300.

The mat 300 is configured to receive water from an external source and distribute and uniformly retain the water across the interior core layer for distribution to the one or more potted plants 310 on the mat 300. When the one or more potted plants 310 are placed on the water distribution mat 300, water is passed up through the mat 300 to the one or more potted plants 310. In some embodiments, the water is passed up to the one or more potted plants 310 by capillary action. Particularly, as described above, as the top layer 305 flexes, the one or more potted plants 305 depress slightly into the soft core layer below the top layer 305. Then, as shown within FIG. 3, the water is carried by the roots up from the soil and up into the one or more plants 310. Consequently the water, which contains dissolved nutrients, gets inside the roots and starts climbing up the plant tissue. In this manner, the one or more potted plants 310 are able to absorb water and nutrients from the water distribution mat 300 as needed by the one or more potted plants 310. As described above, any appropriate style of pot is able to be used so long as it is able to receive water in a bottom-up fashion. For example, in some embodiments, the one or more pots comprise one or more holes, slots, or channels that enable water to be passed up to the potted plant. Alternatively, in some embodiments the one or more pots comprise a porous surface which enables the water to pass to the one or more plants.

FIG. 4 illustrates a method of watering one or more potted plants in accordance with some embodiments. The method begins in the step 410. In the step 420 water is supplied to a composite water distribution mat. In some embodiments, the water distribution mat comprises a base layer, a top layer, an edge, and one or more wicking tabs. The water is able to be provided to the mat by any appropriate water source including a hose, a watering system, and a watering can or bucket. Then, in the step 430, one or more potted plants are placed on the water distribution mat. As described above, when the one or more potted plants are placed on the water distribution mat, water is passed up through the mat to the one or more potted plants. As described above, any appropriate style of pot is able to be used so long as it is able to receive water in a bottom-up fashion.

When one or more potted plants are placed on a water distribution mat, the plants water themselves from the mat in a consistent manner. Consequently, there is less labor and cost to keeping the potted plants because the potted plants are able to continuously draw water and the mat only needs to be watered after it is emptied. Additionally, there is reduced plant loss due to under or over watering of the plants and plants are not skipped during the day-to-day watering. Further, because the plants are watered in a bottom-up manner, soil nutrients do not get flushed out of the soil due to top-down watering. This also enables reduced water consumption from the elimination of overfilling, splash waste between pots and fast flowing hoses rushing the watering process. Additionally, any wash water runoff and splashed soil spilling to the floor is eliminated. The elimination of splash residue prevents water droplets from contacting plant foliage in hard water regions. Moreover, healthier and longer lasting plants are cultivated because there is no flush-purging of soil nutrient often caused by top-down watering.

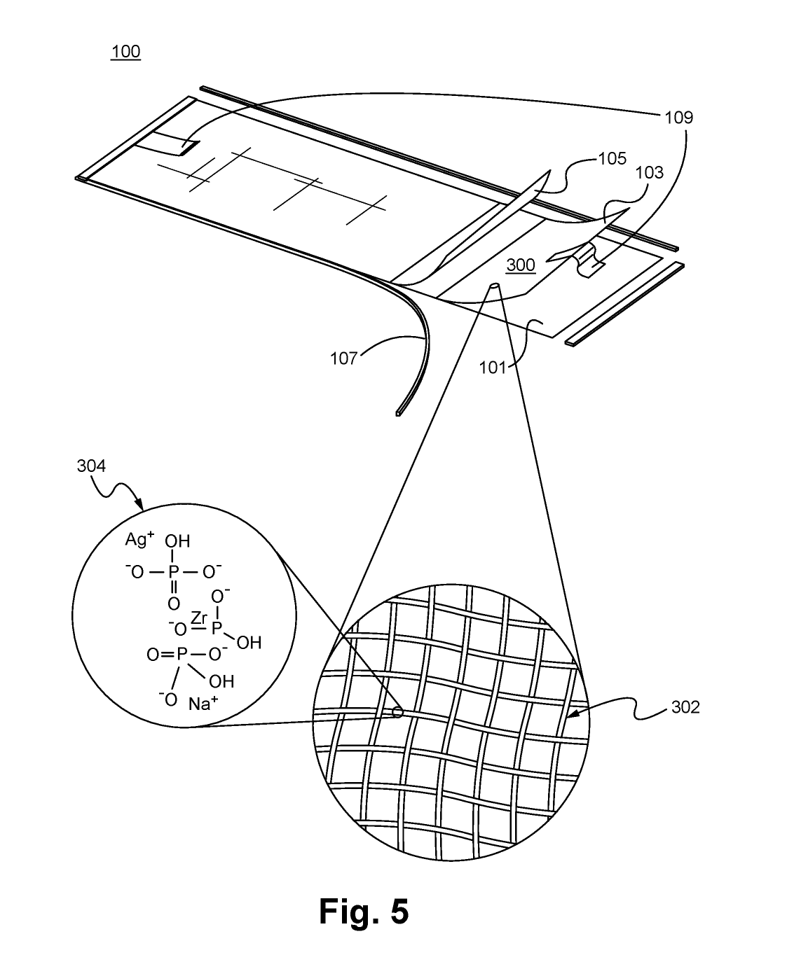

FIG. 5 illustrates an antimicrobial core layer 300 in accordance with some embodiments. The antimicrobial core layer 300 is able to be the core layer 103 of FIG. 1. In some embodiments, the antimicrobial core layer 300 comprises an antimicrobial substance or agent that kills and/or inhibits the growth of microorganisms, such that the growth of mildew or mold is able to be prevented. A person of ordinary skill in the art would appreciate that any chemical substances that are able to kill or inhibit the growth of fungus, bacteria, virus, or and biological substances that are detrimental to human or animal health can be used.

In some embodiments, a material 302 that is part of the core 103 comprises the antimicrobial substance 304. In some embodiments, the material 302 contains fibers, polymers (e.g., polyester), or a mixture thereof. A person of ordinary skill in the art would appreciate that the ratio of the fibers to the polymers are able to be in any ratio, such as 90%:10% and 50%:50%. Further, a person of ordinary skill in the art would appreciate that any other supplemental substances or composition materials are able to be added, such as 1% of antimicrobial nanoparticles (e.g., silver nanoparticles on zirconium oxide or phosphate). In some embodiments, the antimicrobial substance 304 comprises silver sodium hydrogen zirconium phosphate.

In some embodiments, the antimicrobial core layer 300 comprises 98%-99% fibers or polymers with 1% or less of the antimicrobial substance 304 (e.g., silver sodium hydrogen zirconium phosphate). A person of ordinary skill in the art appreciates that the antimicrobial substance 304 is able to be any percentages in the antimicrobial core layer 300 that does not pose a health issue to human or animals, such as 0.01%, 0.5%, 1%, or less than 5% by weight.

In some embodiments, the antimicrobial substance 304 comprises a silver complex, which is able to generate or release silver ions (e.g., Ag⁺). In some embodiments, the antimicrobial substance 304 comprises a zirconium compound, which is able to be in a form (e.g., concentration, dosage, and density) effective in inhibiting or killing microorganisms (e.g., majority, 80%, or 99% if microorganisms) such as zirconium phosphate. In some embodiments, the material 302 and the antimicrobial substance 304 comprise a fiber and ALPHASAN®. In some embodiments, the antimicrobial substance 304 comprises phosphate-based ceramic ion exchange resin containing silver.

A person of ordinary skill in the art would appreciate that any other the antimicrobial substances or microbes inhibiting chemical reagents (e.g., halides (fluoride, chloride, bromide, iodide) are within the scope of the present invention.

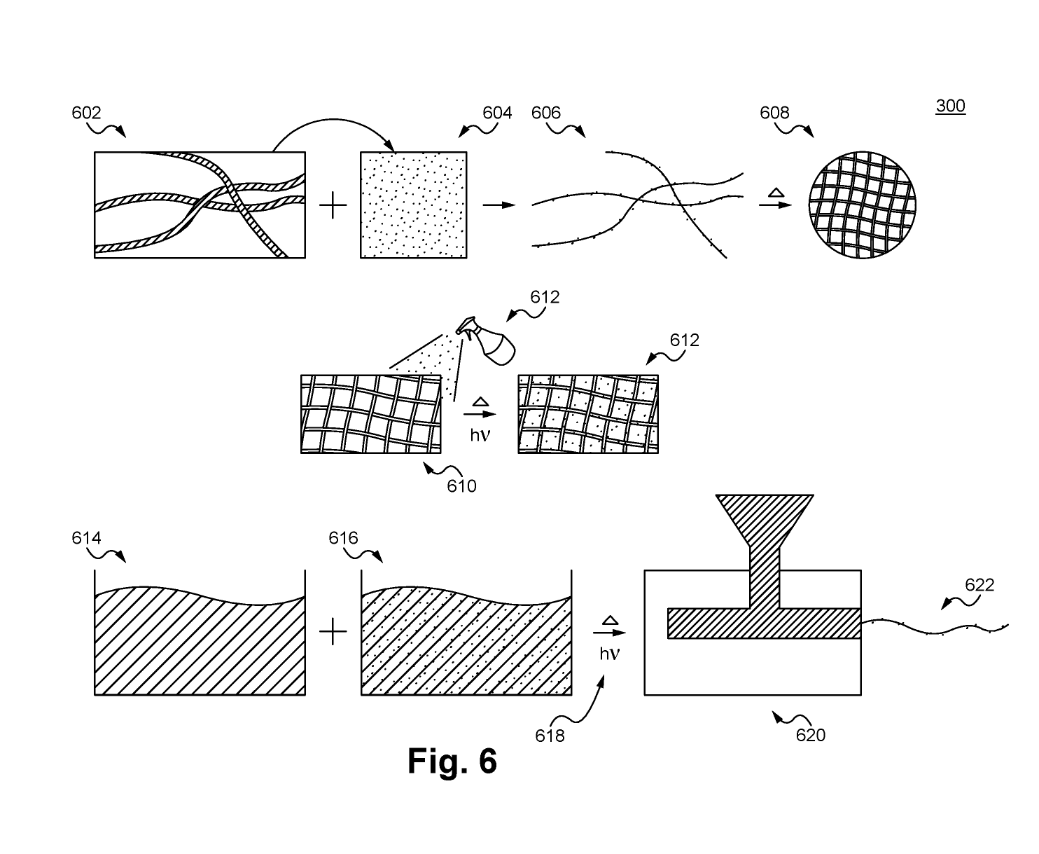

FIG. 6 illustrates a method of making the antimicrobial core layer 300 (as shown in FIG. 5) in accordance with some embodiments. The core layer 300 can be made by various ways, including forming the layer 300 using fibers containing the antimicrobial substances and spraying or applying the antimicrobial substances to a fabric. In some embodiments, an amount of fibers 602 are immersed into a solution 604 containing the antimicrobial substances (e.g., silver sodium hydrogen zirconium phosphate, a silver compound, and a zirconium compound) forming fibers containing the antimicrobial substances 606. The antimicrobial substances 606 are able to be coupled with the fiber via a covalent bond, hydrogen bond, or ionic bond. For example, the monomers forming the fibers can be co-polymerized with the monomers of the antimicrobial substances forming a carbon to carbon covalent bond. In another example, the fiber contains hydroxyl group (OH—) that forms a hydrogen bond using its hydrogen with the oxygen of the antimicrobial substances.

In some embodiments, the fibers containing the antimicrobial substances 606 are used to form the material 608, such as by woven or polymerization. In some embodiments, the material 608 is able to be directly used or further processed (e.g., compressed) to form the core layer 300.

In some embodiments, the core layer 300 is formed by spraying a solution 612 containing the antimicrobial substances. Heat, UV light, drying and other processing procedures are able to be applied to enhancing the bonding (e.g., evaporating the solvent or curing a polymerization reaction) of the antimicrobial substances with the base material (e.g., the fibers or polymers, such as polyester, polyethylene, and polypropylene), such that a material 612 for making the core layer 300 is formed.

In some embodiments, the core layer 300 is formed by co-polymerizing monomers of the fiber material in a solution 614 (e.g., the solvent includes, toluene, hexane, dimethylformamide (DMF), dimethyl solfoxide (DMSO), or a combination thereof) and the monomers of the antimicrobial substances in the solution 616. The monomer of the antimicrobial substances is able to contain one or more double bonds for polymerization/co-polymerization.

In some embodiments, the antimicrobial substances are able to be in the top layer, core layer, bottom layer, or a combination thereof.

In use, the water distribution mat is able to distribute water and nutrients to potted plants individually or in large quantities. The water distribution mat receives water from an external water source, distributes the water uniformly across an interior core layer, and when a potted plant is place on the mat, distributes the water to the potted plant. Particularly, the water distribution mat distributes water to the potted plants in an efficient manner and on an as needed basis because the plants will only seek the water when it is needed. Further, because multiple potted plants are able to be placed on the mat, multiple potted plants are simultaneously watered and with the correct amount of water. Accordingly, the composite mat for water distribution to one or more potted plants as described herein has many advantages.

The invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications area able to be made in the embodiment chosen for illustration without departing from the spirit and scope of the invention. Specifically, it will be apparent that the design for the composite mat is able to be implemented in many different styles and configurations. Further, it will be apparent to one of ordinary skill in the art that the precise structure of the device is able to be substantially varied to accommodate various styles of potted plants and water sources. Consequently, the claims should be broadly construed, consistent with the spirit and scope of the invention, and should not be limited to their exact, literal meaning.

We claim:

1. A water distribution mat for one or more potted plants comprising:
a. a base layer;
b. a top layer; and
c. a core layer for retaining water and distributing the water through the top layer and to the one or more potted plants located on the mat, wherein the core layer comprises an antimicrobial substance.

2. The mat of claim 1, wherein the antimicrobial substance comprises silver sodium hydrogen zirconium phosphate.

3. The mat of claim 1, wherein the antimicrobial substance comprises a silver compound.

4. The mat of claim 1, wherein the antimicrobial substance comprises zirconium.

5. The mat of claim 4, wherein the zirconium comprises a zirconium phosphate compound.

6. The mat of claim 4, wherein the core layer comprises a fabric based material containing the antimicrobial substance.

7. A bottom-up water distribution system for one or more potted plants comprising:
a. a perforated top layer comprising a slit-film propylene material;
b. a core layer comprising a needled polyester viscose or lyocel non-woven felt substrate and for holding a quantity of water, wherein the core layer comprises an antimicrobial substance; and
c. a base layer comprising a polyethylene film material.

8. The system of claim 7, wherein the antimicrobial substance comprises silver sodium hydrogen zirconium phosphate.

9. The system of claim 7, wherein the antimicrobial substance comprises a silver compound.

10. The system of claim 7, wherein the antimicrobial substance comprises a zirconium phosphate compound.

11. A method of watering one or more potted plants comprising:
a. supplying water to a composite mat comprising:
i. a base layer;
ii. a top layer; and
iii. a core layer, wherein the core layer comprises an antimicrobial substance; and
b. placing the one or more potted plants on the composite mat, wherein water is retained within the core layer and distributed through the top layer and to the one or more potted plants.

12. The method of claim 11, wherein the antimicrobial substance comprises silver sodium hydrogen zirconium phosphate.

13. The method of claim 11, wherein the antimicrobial substance comprises a silver compound.

14. The method of claim 11, wherein the antimicrobial substance comprises a zirconium compound.

15. A method of watering one or more potted plants comprising:
a. supplying water to a water distributing layer of a composite mat, wherein the water distributing layer comprises an antimicrobial substance; and
b. placing the one or more potted plants on the composite mat, wherein water is retained within the water distributing layer and distributed through a top layer and to the one or more potted plants.

16. The method of claim 15, wherein the antimicrobial substance comprises silver sodium hydrogen zirconium phosphate.

17. The method of claim 15, wherein the water distributing layer comprises polyester viscose.

18. The method of claim 15, wherein the water distributing layer comprises a non-woven felt substrate.

19. The method of claim 15, wherein the top layer comprises a slit-film material.

20. The method of claim 15, wherein the top layer comprises a porous film material.
